(19) United States
(12) Patent Application Publication
(10) Pub. No.: US 2014/0362198 A1
(43) Pub. Date: Dec. 11, 2014

(54) Stereoscopic Video Processor, Stereoscopic Video Processing Method and Stereoscopic Video Processing Program

(71) Applicants: Kabushiki Kaisha Toshiba, Tokyo (JP); Toshiba Lifestyle Products & Services Corporation, Tokyo (JP)

(72) Inventor: Io Nakayama, Ome (JP)

(21) Appl. No.: 14/468,090

(22) Filed: Aug. 25, 2014

Related U.S. Application Data
(63) Continuation of application No. PCT/JP2013/059535, filed on Mar. 29, 2013.

(51) Int. Cl. H04N 13/04

(52) U.S. Cl. CPC H04N 13/0459
USPC 348/54

(57) ABSTRACT

An electronic apparatus according to an embodiment is provided with circuitry to separate a video signal for stereoscopic video display into a first signal of a background and a second signal of a foreground, and to determinate a first maximum depth position and a first maximum projection position with respect to the first signal, and to determinate a second maximum depth position and a second maximum projection position with respect to the second signal.

### CROSS REFERENCE TO RELATED APPLICATIONS

This application is a Continuation Application of PCT Application No. PCT/JP2013/059535, filed Mar. 29, 2013, the entire contents of which are incorporated herein by reference.

### FIELD

Embodiments described herein relate generally to a stereoscopic video processor, a stereoscopic video processing method and a stereoscopic video processing program.

### BACKGROUND

As is well known, a technique has been developed for having the user recognize a three-dimensional image by using a planar video display screen. In this technique, two types of images are prepared in such a way that the images mutually have a parallax corresponding to the distance between the eyes of a human. An image for the right eye is recognized by the right eye of the user, and an image for the left eye is recognized by the left eye. In this manner, the eyes of a human view the images stereoscopically.

As an example of the technique, a shutter glasses system has been put into practice and is popular with consumers. In the system, an image for the right eye and an image for the left eye are alternately displayed on the same video display screen. The stereoscopic glasses worn by the user are controlled in the following manner: the left-eye shutter is closed when the image for the right eye is displayed, and the right-eye shutter is closed when the image for the left eye is displayed. By this control, the user can view a stereoscopic image.

An unaided stereoscopic video display technology by a multiple parallax system has been also put into practical use. In this system, many parallax images having different viewpoints are displayed on a video display screen. The output direction of the light beams from the parallax images is controlled by a light-beam controlling element such as a lens or barrier covering the screen. By this control, the user can view a stereoscopic image without using stereoscopic glasses.

The users have different tastes in viewing a stereoscopic image. Some users prefer a stereoscopic image which is eye-friendly and gentle; in other words, an image whose degree of projection/depth is small. Others prefer an image whose stereoscopic effect is emphasized; in other words, an image whose degree of projection/depth is large. As an object being imaged, in a landscape image, the sweep effect of the depth of the background is regarded as important. In an article image, in which an article is imaged in detail, weight is attached to the uneven effect of the inside of the article.

However, in the current technique for displaying a stereoscopic image, as the degree of projection/depth, only two points which are the maximum projection position and the maximum depth position are adjustable. For this reason, the degree of projection/depth cannot be adjusted in detail in accordance with the user's preference or the object to be displayed. Thus, it is not possible to display an image with an optimum stereoscopic effect.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block configuration diagram shown for schematically explaining an example of a signal processing system of a digital television broadcasting receiver as an embodiment;

FIG. 2 is an external appearance diagram shown for explaining an example of a remote controller used in the digital television broadcasting receiver in the embodiment;

FIG. 3 is a block configuration diagram shown for explaining an example of a degree-of-depth determination module provided in the digital television broadcasting receiver in the embodiment;

FIG. 4 is shown for explaining an example of the operation of the degree-of-depth determination module in the embodiment;

FIG. 5 is shown for explaining an example of the display position of a depth-determination screen displayed by the degree-of-depth determination module in the embodiment;

FIG. 6 is shown for explaining an example of the depth-determination screen in the embodiment;

FIG. 7 is shown for explaining an example of a case where the depth-determination screen in the embodiment is used in order to adjust the depth; and

FIG. 8 is shown for explaining an example of a mode setting screen displayed by the digital television broadcasting receiver in the embodiment.

### DETAILED DESCRIPTION

Various embodiments will be described hereinafter with reference to the accompanying drawings.

In general, according to one embodiment, an electronic apparatus is provided with circuitry to separate a video signal for stereoscopic video display into a first signal of a background and a second signal of a foreground, and to determinate a first maximum depth position and a first maximum projection position with respect to the first signal, and to determinate a second maximum depth position and a second maximum projection position with respect to the second signal.

Hereinafter, embodiments are described in detail with reference to the accompanying drawings. According to an embodiment, a stereoscopic video processor comprises a separation module and an determination module. The separation module separates a video signal for stereoscopic video display into a background and a foreground. The determination module independently determinates each of a maximum depth position and a maximum projection position with respect to a video signal of the background and the foreground which are separated by the separation module.

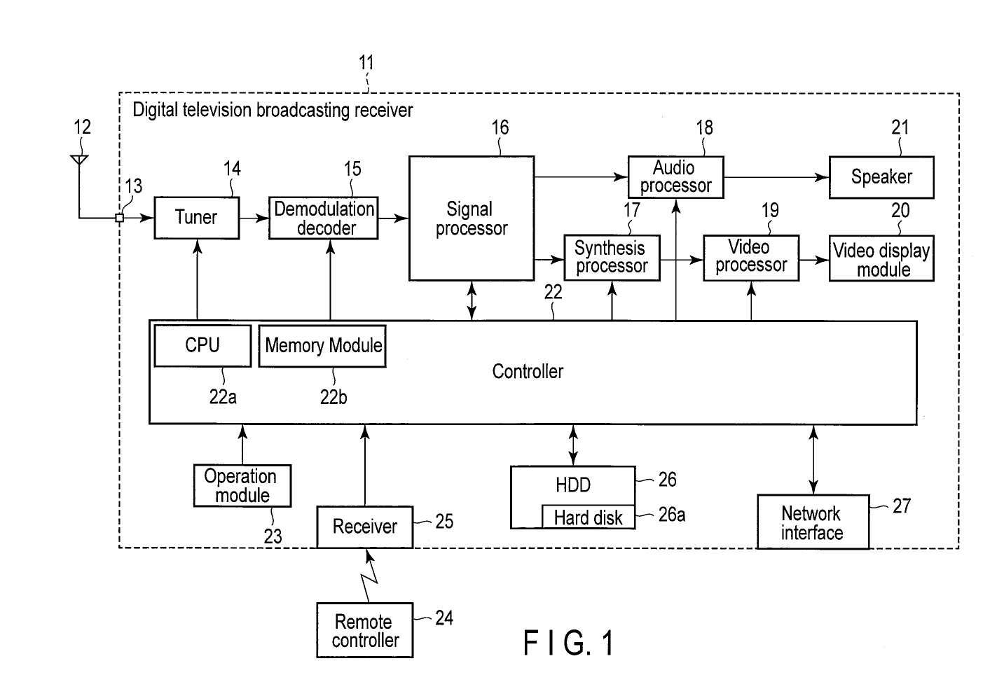

FIG. 1 schematically shows a signal processing system of a digital television broadcasting receiver 11 explained in the present embodiment. The digital television broadcasting receiver 11 is capable of displaying an image based on a video signal for normal planar view (two-dimensional) display. In addition, the digital television broadcasting receiver 11 is capable of displaying an image based on a video signal for stereoscopic (three-dimensional) display.

A digital television broadcasting signal received in an antenna 12 is supplied to a tuner 14 via an input terminal 13. In this manner, a broadcasting signal of a desired channel is selected. The broadcasting signal selected in the tuner 14 is supplied to a demodulation decoder 15, is restored as a digital video signal, a digital audio signal and the like, and is output to a signal processor 16.

The signal processor 16 (circuitry) applies a predetermined digital signal process to each of the digital video signal and the digital audio signal which are supplied from the demodulation decoder 15. The predetermined digital signal process performed by the signal processor 16 includes a process of converting a video signal for normal planar view display into a video signal for stereoscopic display, and a process of adjusting the degree of depth of the converted video signal for stereoscopic display. The predetermined digital signal process is explained in detail later.

The signal processor 16 outputs the digital video signal to a synthesis processor 17, and outputs the digital audio signal to an audio processor 18. The synthesis processor 17 superimposes an on-screen-display (OSD) signal onto the digital video signal supplied from the signal processor 16 and outputs the signal. The digital video signal output from the synthesis processor 17 is supplied to a video processor 19.

The video processor 19 converts the input digital video signal into a format displayable in, for example, a video display module 20 provided in the subsequent stage. The video display module 20 is planar and comprises a liquid crystal display panel and the like. The video signal output from the video processor 19 is supplied to the video display module 20 and is displayed as an image.

In a case where the video signal supplied from the synthesis processor 17 is a video signal for stereoscopic display, the video processor 19 applies, to a video signal for the right eye and a video signal for the left eye of the video signal for stereoscopic display, a process of alternately outputting the video signal for the right eye and the video signal for the left eye in a double speed in frame, and a process of reducing three-dimensional crosstalk by using an overdrive technology.

Moreover, in the case where the video signal supplied from the synthesis processor 17 is a video signal for stereoscopic display, the video processor 19 generates a shutter control signal indicating each of a period for displaying an image for the right eye and a period for displaying an image for the left eye, and outputs the shutter control signal to stereoscopic glasses (not shown in the figure).

Based on the shutter control signal supplied from the video processor 19, the stereoscopic glasses are controlled such that the left-eye shutter is closed when the image for the right eye is displayed and the right-eye shutter is closed when the image for the left eye is displayed. Thus, a stereoscopic image is recognized by the user.

The audio processor 18 converts the input digital sound signal into an analogue audio signal having a format reproducible in a speaker 21 provided in the subsequent stage. The analogue audio signal output from the audio processor 18 is supplied to the speaker 21 and is reproduced as sound.

All of the operations of the digital television broadcasting receiver 11 are controlled by a controller 22 as a whole, including various reception operations described above. The controller 22 comprises a built-in central processing unit (CPU) 22a. The controller 22 receives operation information from an operation module 23 provided in the main body of the digital television broadcasting receiver 11, or receives operation information which is transmitted from a remote controller 24 and received by a receiver 25. The controller 22 controls each module such that the operation information can be reflected.

In this case, the controller 22 utilizes a memory module 22b. The memory module 22b mainly comprises a read-only memory (ROM) in which a control program executed by the CPU 22a is stored, a random access memory (RAM) for providing the CPU 22a with a working area, and a nonvolatile memory in which various types of setting information and control information are stored.

A hard disk drive (HDD) 26 is connected to the controller 22. Based on the operation conducted by the user through the operation module 23 or the remote controller 24, the controller 22 is capable of controlling the digital video signal and the digital audio signal restored in the signal processor 16 such that the signals are supplied to the HDD 26 and recorded in a hard disk 26a.

Further, based on the operation conducted by the user through the operation module 23 or the remote controller 24, the controller 22 causes the HDD 26 to read the digital video signal, the digital sound signal and the like from the hard disk 26a, and supplies the signals to the signal processor 16. In this manner, the controller 22 is capable of controlling the signals such that they are displayed as an image and reproduced as sound as stated above.

A network interface 27 is connected to the controller 22. The network interface 27 is connected to a network such as the Internet (not shown in the figure). A network server is connected to the network in order to provide various types of services by using the communication function via the network.

Based on the operation conducted by the user through the operation module 23 or the remote controller 24, the controller module 22 accesses the network server and performs data communication via the network interface 27 and the network. In this manner, the controller 22 is capable of using the services offered by the network server.

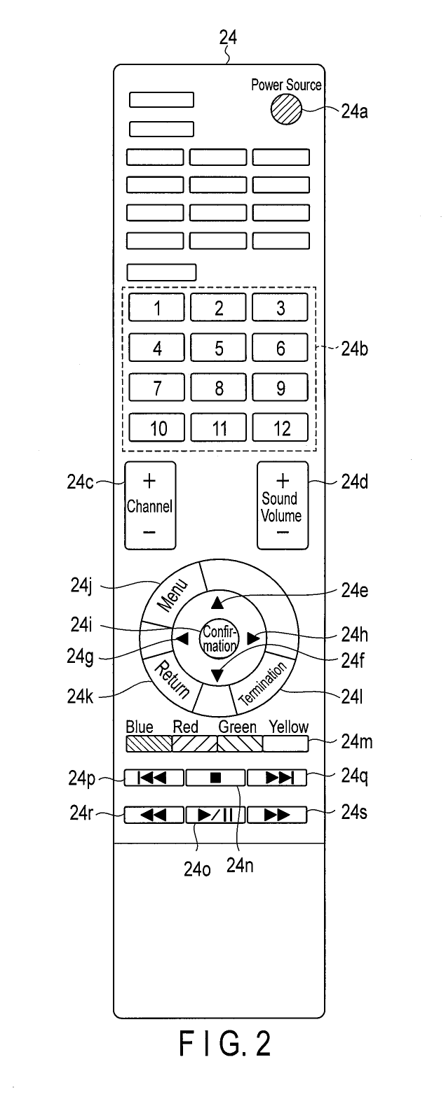

FIG. 2 illustrates the external appearance of the remote controller 24. The remote controller 24 mainly comprises a power source key 24a, a numeric keypad 24b, a channel-up/down key 24c, a sound volume control key 24d, a cursor-up key 24e, a cursor-down key 24f, a cursor-left key 24g, a cursor-right key 24h, a confirmation key 24i, a menu key 24j, a return key 24k, a termination key 24l, and four color keys (blue, red, green and yellow) 24m.

The remote controller 24 further comprises, for example, a playback stop key 24n, a playback/pause key 24o, a backward-skip key 24p, a forward-skip key 24q, a fast-backward key 24r and a fast-forward key 24s. It is possible to apply playback, stop and pause to the HDD 26 by pressing the playback stop key 24n and the playback/pause key 24o of the remote controller 24.

By pressing the backward-skip key 24p and the forward-skip key 24q of the remote controller 24, it is possible to skip the video and audio data which is read from the hard disk 26a by the HDD 26 by a certain amount in the backward direction and the forward direction relative to the playback direction of the data. These types of skips are called a backward-skip and a forward-skip.

By pressing the fast-backward key 24r and the fast-forward key 24s of the remote controller 24, etc., it is possible to continuously replay the video and audio data which is read from the hard disk 26a by the HDD 26 at high speed in the backward direction and the forward direction relative to the playback direction of the data. These types of replays are called fast-backward playback and fast-forward playback.

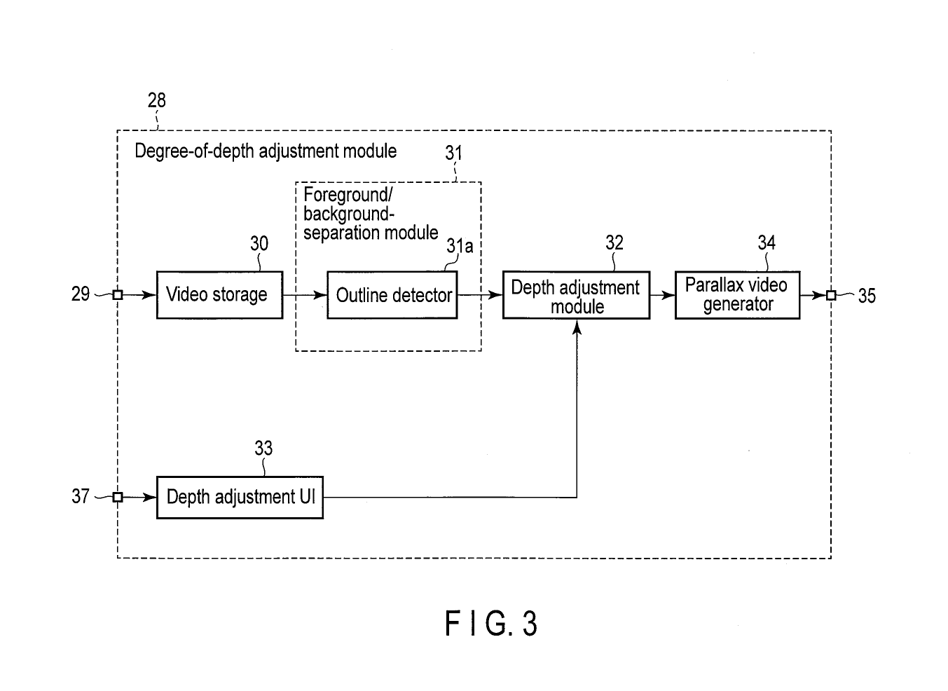

FIG. 3 illustrates an example of a degree-of-depth determination module (determiner) 28 provided in the signal processor 16. The degree-of-depth determination module 28 has a function for converting a video signal for normal planar view display into a video signal for stereoscopic display, and adjusting the degree of projection/depth of the converted video signal for stereoscopic display. The degree-of-depth determination module 28 comprises an input terminal 29 to which the video signal for planar view display restored in the demodulation decoder 15 is supplied.

The video signal for planar view display supplied to the input terminal 29 is supplied to a video storage 30 and stored for one frame. The video signal stored in the video storage 30 is supplied to a foreground/background-separation module 31 and separated into a foreground and a background.

The video signal for planar view display read from the video storage 30 is supplied to an outline detector 31a. The outline detector 31a detects an outline component from the input video signal in order to separate the input image into a foreground and a background.

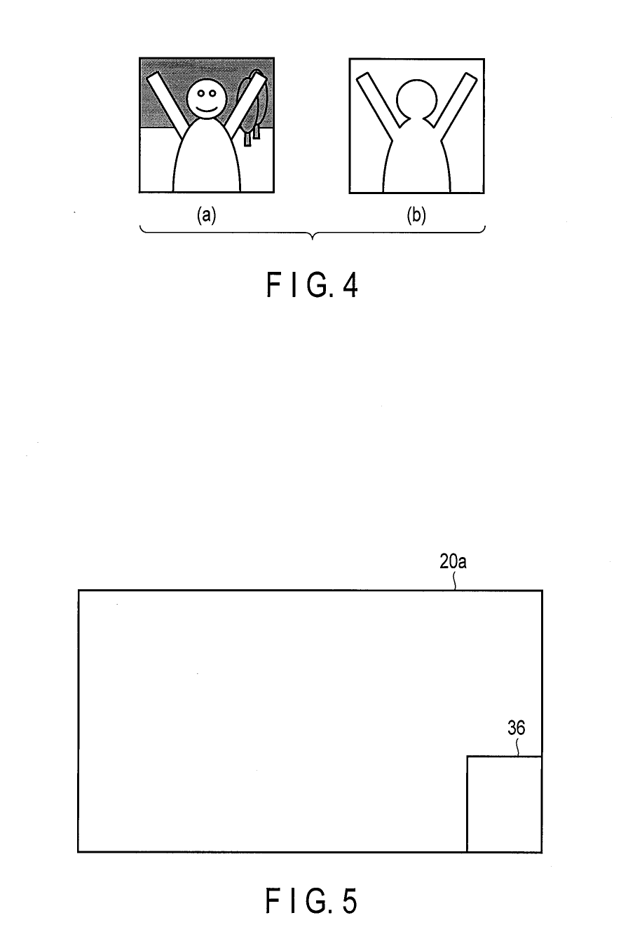

FIG. 4(a) shows an example of an image corresponding to the video signal read from the video storage 30, or in other words, an example of an image input in the foreground/background-separation module 31. FIG. 4(b) shows an example of an image corresponding to the video signal of the foreground output from the outline detector 31a, or in other words, an example of a foreground image separated in the foreground/background-separation module 31.

The foreground and the background of the video signal separated in the foreground/background-separation module 31 are supplied to a depth determination module 32 in a block unit consisting of several pixels. The depth determination module 32 sets a degree of projection/depth for generating a stereoscopic image relative to the video signal input in a block unit. Based on foreground-depth-determination information output from a depth determination user interface (UI) 33, the depth determination module 32 independently determinates each of the maximum projection position and the maximum depth position of the foreground of the input image signal. In addition, based on background-depth-determination information output from the depth determination UI 33, the depth determination module 32 independently determinates each of the maximum projection position and the maximum depth position of the background of the input image signal.

As described above, with respect to the foreground and the background, each of the maximum projection position and the maximum depth position is independently adjusted by the depth determination module 32. The video signal adjusted in this manner is supplied to a parallax video generator 34, and is supplied to the synthesis processor 17 via an output terminal 35 after, for example, a video signal for the right eye and a video signal for the left eye are generated.

As shown in FIG. 5, by the depth determination UI 33, a depth-determination screen 36 is displayed such that the screen overlaps with the display image by the stereoscopic video signal at the lower right corner of a display screen 20a of the video display module 20. The depth-determination screen 36 can be displayed when the user goes deep into a plurality of menu screens having a hierarchical structure by pressing the menu key 24j of the remote controller 24.

The user operates the remote controller 24 on the depth-determination screen 36. This operation information input by the user is supplied via an input terminal 37. By this supply, the depth determination UI 33 generates foreground-depth-determination information specifying the maximum projection position and the maximum depth position of the foreground, and background-depth-determination information specifying the maximum projection position and the maximum depth position of the background.

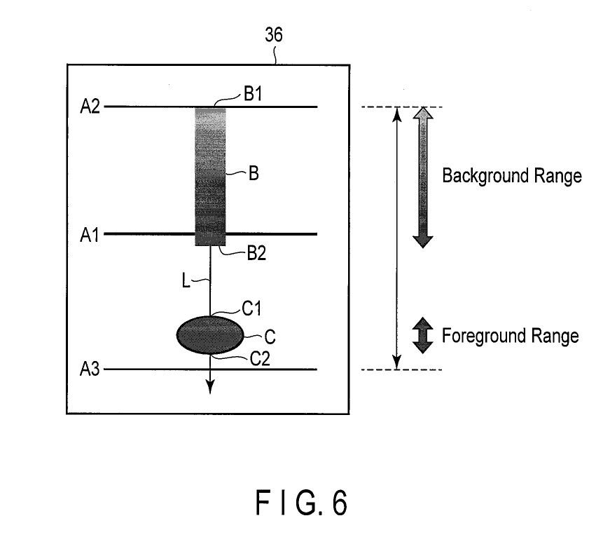

FIG. 6 shows an example of the depth-determination screen 36. The depth-determination screen 36 displays a line segment L. The length of the line segment L in the vertical direction indicates the degree of projection/depth which can be depicted by the digital television broadcasting receiver 11. The central portion of the line segment L is a screen position A1 which corresponds to the display screen 20a of the video display module 20. The upper end portion of the line segment L is a maximum depth position A2. The lower end portion of the line segment L is a maximum projection position A3.

Along the line segment L corresponding to the degree of projection/depth, the depth-determination screen 36 displays a background-determination icon B for adjusting the degree of projection/depth of the background image, and a foreground-determination icon C for adjusting the degree of projection/depth of the foreground image. The length of the background-determination icon B in the vertical direction shows the determination range of the degree of projection/depth of the background. The upper end portion of the background-determination icon B is a maximum depth position end B1 for specifying the maximum depth position of the background. The lower end portion of the background-determination icon B is a maximum projection position end B2 for specifying the maximum projection position of the background.

When the user moves the cursor (not shown in the figure) over the maximum depth position end B1 of the background-determination icon B by selectively pressing the cursor-up, cursor-down, cursor-left and cursor-right keys 24e to 24h of the remote controller 24, and presses the confirmation key 24i, the maximum depth position end B1 is set to be moved together with the cursor. Accordingly, when the user selectively presses the cursor-up or cursor-down key 24e or 24f, the maximum depth position end B1 is moved in the vertical direction along the line segment L. When the user determines the position of the maximum depth position end B1 and presses the confirmation key 24i, the co-movement of the maximum depth position end B1 with the cursor is released, and this position is determined as the maximum depth position of the background.

When the user moves the cursor over the maximum projection position end B2 of the background-determination icon B by selectively pressing the cursor-up, cursor-down, cursor-left and cursor-right keys 24e to 24h of the remote controller 24, and presses the confirmation key 24i, the maximum projection position end B2 is set to be moved together with the cursor. Accordingly, when the user selectively presses the cursor-up or cursor-down key 24e or 24f, the maximum projection position end B2 is moved in the vertical direction along the line segment L. When the user determines the position of the maximum projection position end B2 and presses the confirmation key 24i, the co-movement of the maximum projection position end B2 with the cursor is released, and this position is determined as the maximum projection position of the background.

When the maximum depth position and the maximum projection position of the background are determined in the above manner, the depth determination UI 33 generates background-depth-determination information specifying the maximum projection position and the maximum depth position of the background, and outputs the information to the depth determination module 32. With this configuration, in the depth determination module 32, it is possible to independently adjust the maximum projection position and the maximum depth position of the background of the input stereoscopic video signal.

The length of the foreground-determination icon C in the vertical direction indicates the determination range of the degree of projection/depth of the foreground. The upper end portion of the foreground-determination icon C is a maximum depth position end C1 for specifying the maximum depth position of the foreground. The lower portion of the foreground-determination icon C is a maximum projection position end C2 for specifying the maximum projection position of the foreground.

When the user moves the cursor over the maximum depth position end C1 of the foreground-determination icon C by selectively pressing the cursor-up, cursor-down, cursor-left and cursor-right keys 24e to 24h of the remote controller 24, and presses the confirmation key 24i, the maximum depth position end C1 is set to be moved together with the cursor. Accordingly, when the user selectively presses the cursor-up or cursor-down key 24e or 24f, the maximum depth position end C1 is moved in the vertical direction along the line segment L. When the user determines the position of the maximum depth position end C1 and presses the confirmation key 24i, the co-movement of the maximum depth position end C1 with the cursor is released, and this position is determined as the maximum depth position of the foreground.

When the user moves the cursor over the maximum projection position end C2 of the foreground-determination icon C by selectively pressing the cursor-up, cursor-down, cursor-left and cursor-right keys 24e to 24h of the remote controller 24, and presses the confirmation key 24i, the maximum projection position end C2 is set to be moved together with the cursor. Accordingly, when the user selectively presses the cursor-up or cursor-down key 24e or 24f, the maximum projection position end C2 is moved in the vertical direction along the line segment L. When the user determines the position of the maximum projection position end C2 and presses the confirmation key 24i, the co-movement of the maximum projection position end C2 with the cursor is released, and this position is determined as the maximum projection position of the foreground.

When the maximum depth position and the maximum projection position of the foreground are determined in the above manner, the depth determination UI 33 generates foreground-depth-determination information specifying the maximum projection position and the maximum depth position of the foreground, and outputs the information to the depth determination module 32. With this configuration, in the depth determination module 32, it is possible to independently adjust the maximum projection position and the maximum depth position of the foreground of the input stereoscopic video signal.

In the embodiment explained above, a video signal for stereoscopic display is separated into the foreground and the background such that each of the maximum projection position and the maximum depth position can be independently adjusted with respect to the foreground and the background. Therefore, it is possible to adjust a stereoscopic effect in detail depending on the preference of the user, the type of object being imaged and the like.

Moreover, each of the maximum projection position and the maximum depth position can be independently adjusted by the user through an easy and simple operation with respect to the foreground and the background. Specifically, in order to independently adjust each of the positions, the user merely moves the cursor by operating the remote controller 24 on the depth-determination screen 36. Thus, the handling method is convenient for the user.

The depth-determination screen 36 is displayed such that the screen overlaps with the display image by the stereoscopic video signal at the corner of the display screen 20a of the video display module 20. Therefore, the user can adjust a stereoscopic effect while looking at the actual stereoscopic display image. The handling method is convenient for the user in this respect as well.

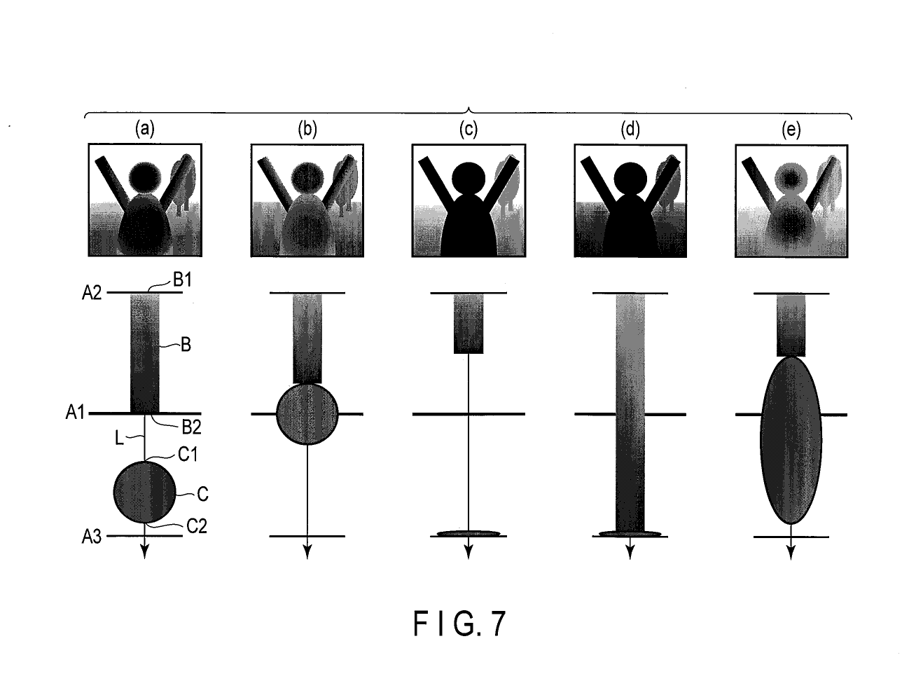

FIGS. 7(a) to 7(e) show typical examples of cases in which each of the maximum projection position and the maximum depth position is independently adjusted with respect to the foreground and the background. In FIGS. 7(a) to 7(e), the stereoscopic display image is displayed such that an image having a lower luminance is displayed at a position closer to the front side. Black indicates an image located in the maximum projection position A3 of the total degree of depth, and white indicates an image located in the maximum depth position A2 of the total degree of depth.

In FIG. 7(a), the maximum depth position end B1 and the maximum projection position end B2 of the background-determination icon B are set to the maximum depth position A2 and the screen position A1 of the total degree of depth respectively. Further, the maximum depth position end C1 and the maximum projection position end C2 of the foreground-determination icon C are set between the screen position A1 and the maximum projection position A3 of the total degree of depth. By this determination, the background is seen behind the screen position A1, and only the foreground pops up at the front of the screen position A1. Thus, the most standard stereoscopic effect can be obtained from this determination.

In FIG. 7(b), the central portion between the maximum depth position end C1 and the maximum projection position end C2 of the foreground-determination icon C is set to the screen position A1 of the total degree of depth. Further, the maximum depth position end B1 and the maximum projection position end B2 of the background-determination icon B are set to the maximum depth position A2 of the total degree of depth and the maximum depth position end C1 of the foreground-determination icon C respectively. By this determination, the foreground is seen at the position of the display screen 20a, and the depth of the foreground and the depth of the background are continuous. Therefore, the user can obtain a stereoscopic effect which is eye-friendly and gentle.

In FIG. 7(c), the background-determination icon B is allocated near the maximum depth position A2 of the total degree of depth, and the foreground-determination icon C is allocated near the maximum projection position A3 of the total degree of depth. Thus, the background-determination icon B is not continuous with the foreground-determination icon C. By this determination, the background is seen in a deep position, and the foreground pops up on the front side at a maximum. In this manner, it is possible to obtain a powerful stereoscopic effect.

In FIG. 7(d), the foreground-determination icon C is allocated near the maximum projection position A3 of the total degree of depth, and the background-determination icon B occupies a large part of the total degree of depth. By this determination, the wide sweep of landscapes such as grassland and the sea is emphasized, thereby enhancing the spaciousness.

In FIG. 7(e), the background-determination icon B is allocated near the maximum depth position A2 of the total degree of depth, and the foreground-determination icon C occupies a large part of the total degree of depth across the screen position A1 of the total degree of depth. By this determination, in an article image which is taken in a position close to an article, the shape and the inner irregularity of the article are emphasized.

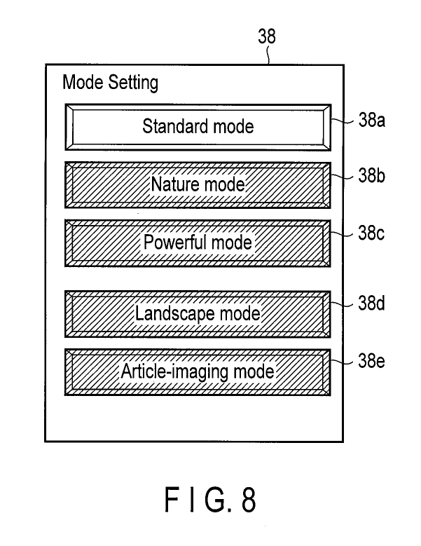

The determination position of the background-determination icon B and the foreground-determination icon C in each of FIGS. 7(a) to 7(e) can be saved in, for example, the memory module (memory) 22b, corresponding to a stereoscopic video display mode. The user presses the menu key 24j of the remote controller 24 and goes deep into a plurality of menu screens having a hierarchical structure such that the video display module 20 displays a mode setting screen 38. FIG. 8 shows an example of the mode setting screen 38.

On the mode setting screen 38, it is possible to prepare a plurality of (in the figure, five) mode keys 38a to 38e. The user can add a title to each of the prepared mode keys 38a to 38e. FIG. 8 shows a state in which five mode keys 38a to 38e are prepared and are titled as a standard mode, a nature mode, a powerful mode, a landscape mode and an article-imaging mode respectively.

It is possible to save the determination position shown in FIG. 7(a) such that the position corresponds to the standard mode key 38a. It is possible to save the determination position shown in FIG. 7(b) such that the position corresponds to the nature mode key 38b. It is possible to save the determination position shown in FIG. 7(c) such that the position corresponds to the powerful mode key 38c. It is possible to save the determination position shown in FIG. 7(d) such that the position corresponds to the landscape mode key 38d. It is possible to save the determination position shown in FIG. 7(e) such that the position corresponds to the article-imaging mode key 38e.

In this configuration, the user displays the mode setting screen 38 and presses the desired mode keys 38a to 38e. By this operation, a stereoscopic image can be displayed in the determination positions saved corresponding to the pressed mode keys 38a to 38e with respect to the background-determination icon B and the foreground-determination icon C.

In the above explanations, the user saves the determination positions of the background-determination icon B and the foreground-determination icon C such that the positions correspond to the mode keys 38a to 38e. However, instead of the save by the user, when the digital television broadcasting receiver 11 is shipped from factories, it is possible to prepare in advance the mode setting screen 38 including the mode keys 38a to 38e corresponding to the determination positions of the background-determination icon B and the foreground-determination icon C in FIGS. 7(a) to 7(e) respectively.

In the above embodiment, this specification explains the digital television broadcasting receiver 11 conducting stereoscopic video display by the shutter glasses system. However, in a receiver conducting unaided stereoscopic video display by the multiple parallax system, it is also possible to independently adjust each of the maximum projection position and the maximum depth position with respect to the background and the foreground.

In the above embodiment, this specification explains the digital television broadcasting receiver 11 converting a video signal for planar view display into a video signal for stereoscopic display. However, in a receiver which obtains a video signal for stereoscopic display from, for example, broadcasts or network servers, each of the maximum projection position and the maximum depth position is independently adjustable with respect to the background and the foreground. In this case, it is also possible to separate the background from the foreground based on the parallax amount of a video signal for stereoscopic display.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
circuitry to separate a video signal for stereoscopic video display into a first signal of a background and a second signal of a foreground, and
to determinate a first maximum depth position and a first maximum projection position with respect to the first signal, and to determinate a second maximum depth position and a second maximum projection position with respect to the second signal.

2. The electronic apparatus of claim 1, wherein
the circuitry is to output an user interface to independently set each of the first maximum depth position, the first maximum projection position, the second maximum depth position, and the second maximum projection position.

3. The electronic apparatus of claim 2, wherein
the input module displays a depth-determination screen and independently sets each of the first maximum depth position, the first maximum projection position, the second maximum depth position, and the second maximum projection position on the depth-determination screen.

4. The electronic apparatus of claim 3, wherein
the depth-determination screen is displayed such that the depth-determination screen overlaps with a part of a stereoscopic display image.

5. The electronic apparatus of claim 3, wherein
the depth-determination screen displays a first icon for independently setting each of the first maximum depth position and the first maximum projection position with respect to the first signal, and a second icon for independently setting each of the second maximum depth position and the second maximum projection position with respect to the second signal.

6. The electronic apparatus of claim 2, further comprising
a memory to save the first and the second maximum depth position and the first and the second maximum projection position which are set by the input module with respect to the first and the second signal such that the first and the second maximum depth position and the first and the second maximum projection position correspond to a stereoscopic video display mode.

7. The electronic apparatus of claim 1, wherein
the determiner specifies a stereoscopic video display mode from a memory in which the first and the second maximum depth position and the first and the second maximum projection position are saved in advance with respect to the first and the second signal such that the first and second maximum depth position and the first and second maximum projection position correspond to the stereoscopic video display mode,
reads the first and the second maximum depth position and the first and the second maximum projection position with respect to the first and the second signal, and uses the first and the second maximum depth position and the first and the second maximum projection position for determination relative to the first and the second signal which are separated by the circuitry.

8. A stereoscopic video processing method, wherein
circuitry separates a video signal for stereoscopic video display into a first signal of a background and a second signal of a foreground, and
to determinate each of a first maximum depth position and a first maximum projection position with respect to the first signal, and to determinate a second maximum depth position and a second maximum projection position with respect to the second signal.

9. A stereoscopic video processing program causing a computer to execute:
a process of separating a video signal for stereoscopic video display into a first signal of a background and a second signal of a foreground; and
a process of independently determining each of a first maximum depth position and a first maximum projection position with respect to the first signal which are separated, and determining each of a second maximum depth position and a second maximum projection position with respect to the second signal which are separated.
